(19) United States
(12) Patent Application Publication
(10) Pub. No.: US 2006/0204646 A1
(43) Pub. Date: Sep. 14, 2006

(54) Method for taking a plant matter print

(76) Inventor: Nobuo Sugino, Yokohama (JP)

Correspondence Address: JORDAN AND HAMBURG LLP, 122 EAST 42ND STREET, SUITE 4000, NEW YORK, NY, 10168, US

(21) Appl. No.: 11/074,403

(22) Filed: Mar. 8, 2005

(51) Int. Cl. A01N 1/00

(52) U.S. Cl. 427/4

(57) ABSTRACT

A method for taking a plant print includes the steps of applying a coloring matter, which is combined a pigment with a fixing agent including one of acryl emulsion, gum alabic, gum tragacanth or selectively and an alcohol, to a plant matter; the step copying and dyeing the plant matter, which is applied the coloring matter, on a copied-and-dyed object by pushing with pressure; and the step doing the ironing by an iron on a back side of the plant matter or a part which is applied the coloring matter. Therefore, since the coloring matter with alcohol is used so as not to shed when the coloring matter is applied to the leaf or flower of the plant matter, any kind of the copied-and-dyed object including paper, cloth cubic object can be copied and dyed easily and beautifully the details of the leaf, and it can be prevented efficiently to lose and change color.

### FIELD OF THE INVENTION

The present invention relates generally to a method for taking a plant print the leaves and flowers of plant matter on papers, clothes and the like.

### BACKGROUND OF THE INVENTION

For the conventional method for taking the leaves print, the sumi ink or coloring matter is applied to the leaves, it is carried out as a stamp.

When the above-mentioned way is operated, the shape of leaves and leaf vein cannot be printed finely.

In addition, since the coloring matter is shed and applied to the spot as the kind of the leaves may be, it is not possible to process it well.

### SUMMARY OF THE INVENTION

Accordingly, it is an object of the present invention to provide a method for taking a plant matter print which can copy and dye the details of the leaves with astonishing dexterity to the sheet typed object or stereoscopic object since the coloring matter with alcohol is used so as not to shed the coloring matter when the coloring matter is applied to the leaves and flowers of the plant matter. it is another object of the present invention to provide a method for taking a plant matter print which can be prevented to change the color and lose dyeing.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE DRAWINGS

FIG. 1 is a flow diagram showing the first embodiment of the present invention;

FIG. 2 is an explanation view showing the way in which the coloring matter is applied to;

FIG. 3 is an explanation view showing the step for copying and dyeing;

FIG. 4 is an explanation view showing the step for doing the ironing;

FIG. 5 is an explanation view showing the way in which the copying and dyeing is finished;

FIG. 6 is a flow diagram showing the second embodiment of the present invention;

FIG. 7 is an explanation view showing the way in which the coloring matter is applied to;

FIG. 8 is an explanation view showing the step for doing the ironing;

FIG. 9 is a flow diagram showing the third embodiment of the present invention;

FIG. 10 is an explanation view showing the way in which the coloring matter is applied to;

FIG. 11 is an explanation view showing the way in which the copying and dyeing is finished;

FIG. 12 is a flow diagram showing the fourth embodiment of the present invention;

FIG. 13 is an explanation view showing the way in which the coloring matter is applied to;

FIG. 14 is an explanation view showing the step for copying and dyeing;

FIG. 15 is a flow diagram showing the fifth embodiment of the present invention;

FIG. 16 is an explanation view showing the way in which the coloring matter is applied to; and

FIG. 17 is an explanation view showing the step for copying and dyeing.

### DETAILED DESCRIPTION OF THE PREFERRED EMBODIMENTS

Preferred embodiments of the present invention are described in more detail below referring to the accompanying drawings.

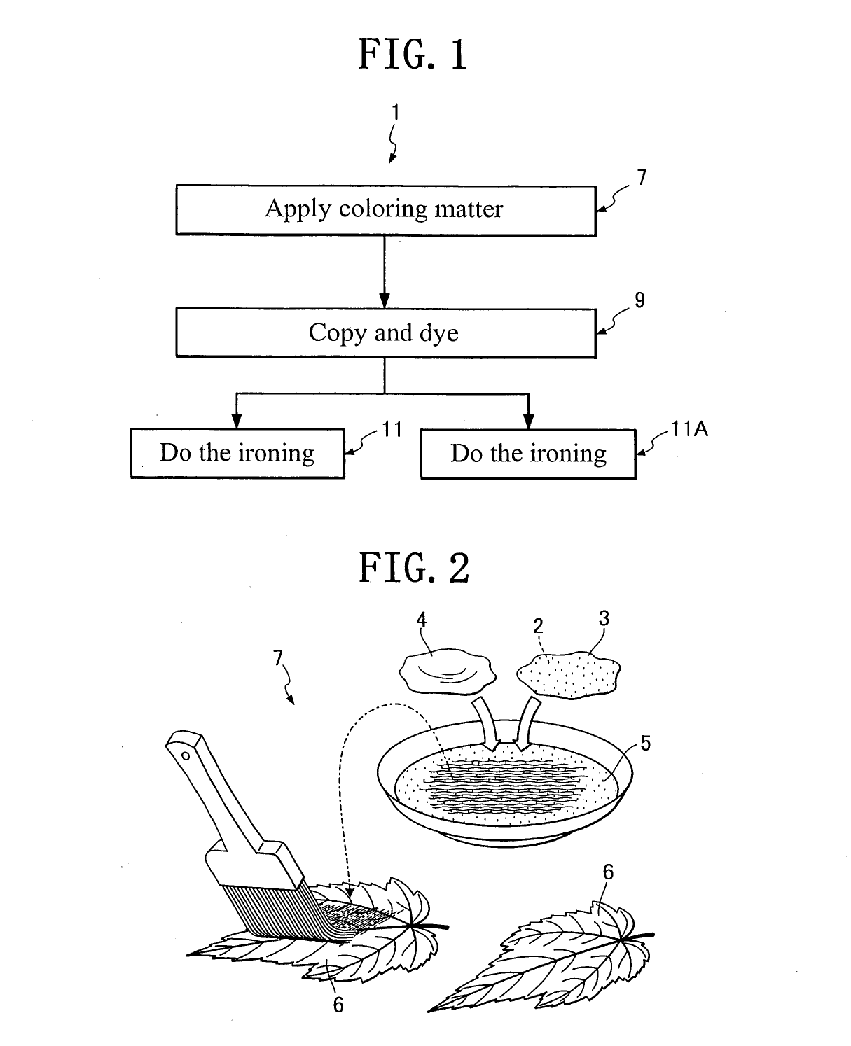

An understanding of the present invention may be best gained by reference FIGS. 1 to 5. The reference numeral 1 is a method for taking a plant print in the present invention which includes a step 7 for applying a coloring matter 5, which is combined a pigment 3 with a fixing agent 2 including acryl emulsion, gum alabic, gum tragacanth or the like and an alcohol 4, to a leaf 6, which is explained in this embodiment, or flower of the plant matter; a step 9 for copying and dyeing the leaf 6, which is applied the coloring matter 5, of the plant matter on paper or cloth as a copied-and-dyed object 8 by pushed pressure; and a step 11 for doing the ironing by an iron 10 on a back side of the leaf 6 of the plant matter.

For the applying step 7, as shown in FIG. 2, in general, the common brush is used in the applying work of the coloring matter, or the paint is sprayed. In addition, the coloring matter 5 maybe applied to one side of the leaf of the plant matter as a part that the user want to copy and dye, for example.

In addition, the coloring matter 5 may be used combined matter with acryl coloring matter, watercolor, pastel- coloring matter and alcohol.

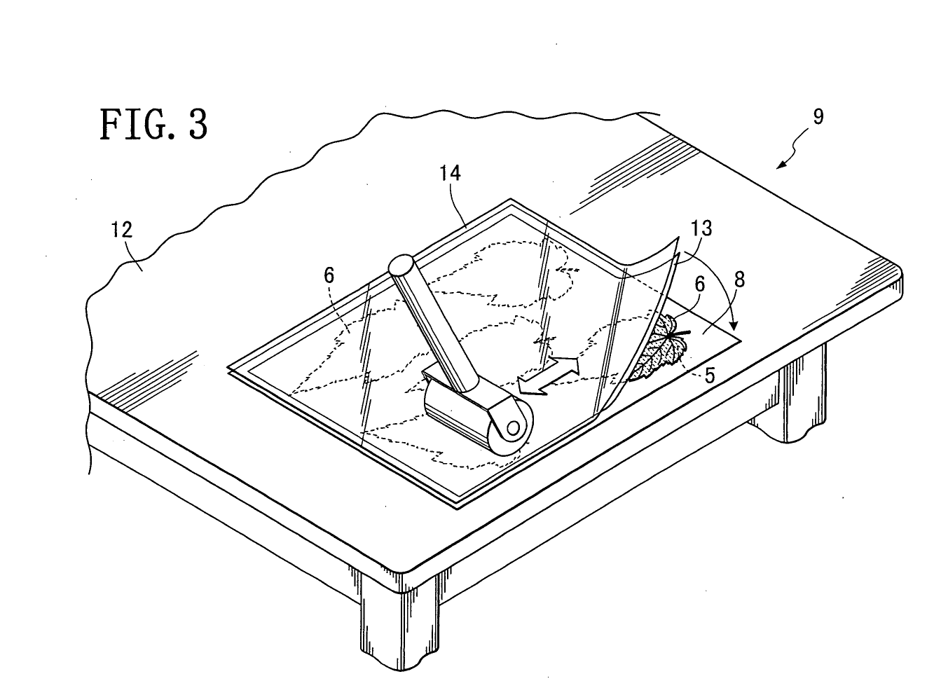

For the copying-and-dyeing step, as shown in FIG. 3, the copied-and-dyed object 8 is put on the table, and the leaf 6 which is applied is arranged on an upper surface of the copied-and-dyed object 8.

After that, an absorbent paper 13 such as tissue, paper with water-absorbing power is positioned on the leaf 6, and a synthetic resin sheet 14 of transparency or translucent is positioned on the absorbent paper 13.

In this condition, when it is pressed over the synthetic resin sheet 14 by the fingertip, roller, spatula and the like, the coloring matter 5 which is applied to the leaf 6 of the plant matter is copied and dyed to the copied-and-dyed object 8.

Then, the coloring matter 5 that sticks out the leaf 6 of the plant matter is absorbed by the absorbent paper 13 and can prevent efficiently to adhere to the copied-and-dyed object 8. In addition, it is understood the state of the pushing pressure of the leaf 6 of the plant matter via the synthetic resin sheet 14 with transparent or translucent and absorbent paper 13, and the uniform pressure is preceded.

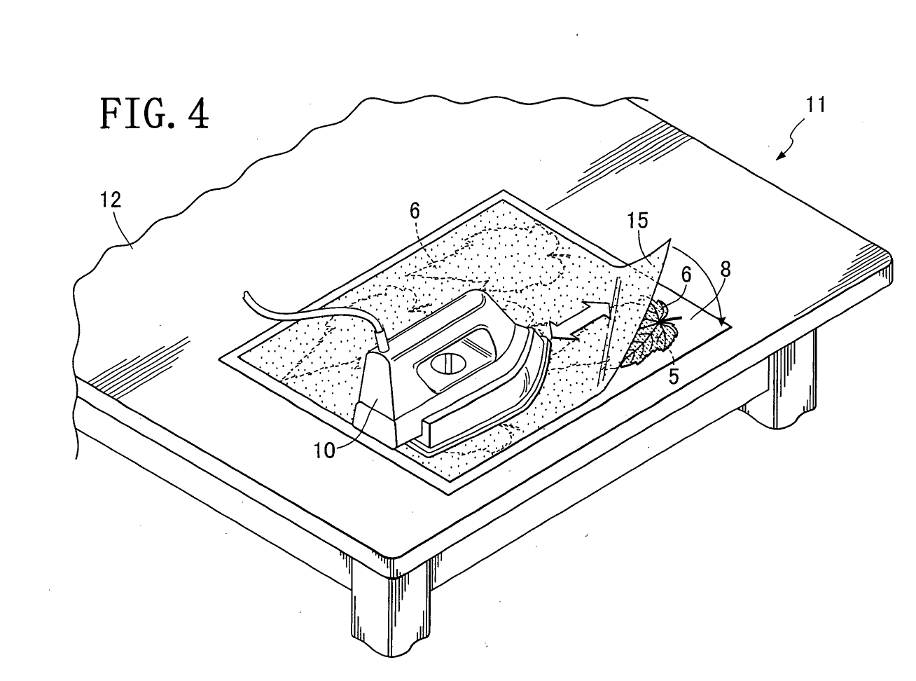

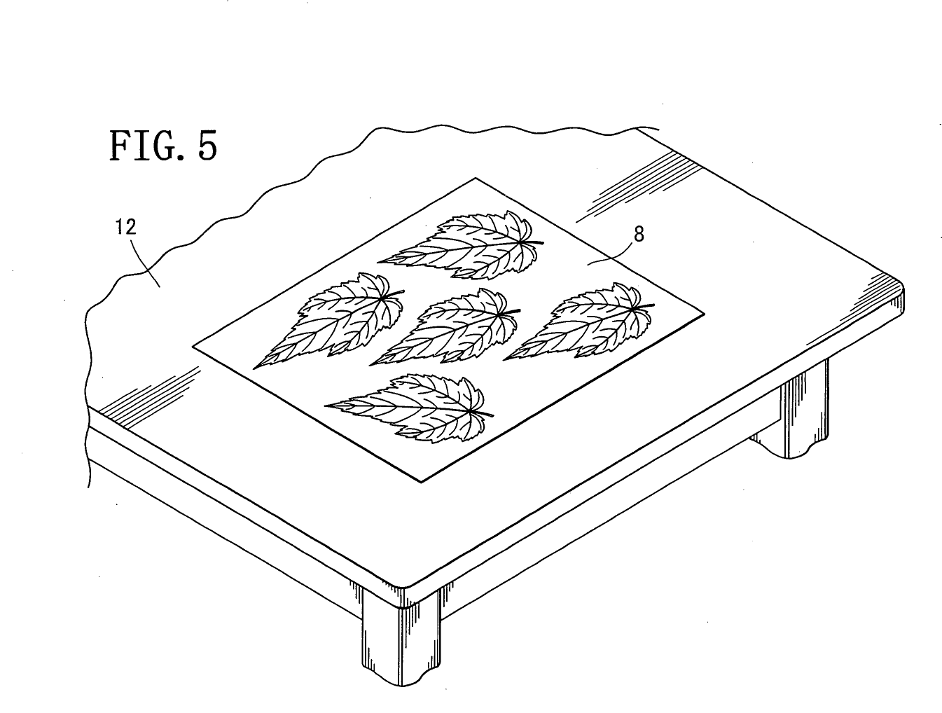

For the ironing step 11, as shown in FIG. 4, after the coloring matter 5 which is applied to the leaf 6 of the plant matter adhered to the copied-and-dyed object 8 fully, the synthetic resin sheet 14 and absorbent paper 13 are removed, and the leaf 6 plant matter or the leaf 6 which is put the cloth 15 thereon is done the ironing by the iron 10. Therefore, acryl emulsion, gum alabic, gum tragacanth and the like which are combined with the coloring matter 5 are melted, and they are firmly fixed to the copied-and-dyed object 8.

After that, when it takes a lot of trouble with removing the leaf 6 from the copied-and-dyed object 8 in order to remove the leaf 6 of the plant matter by doing the ironing, a step 1 1A may be proceeded to do the ironing to a portion 8a for copying and dyeing in the copied-and-dyed object 8 after the synthetic resin sheet 14, absorbent paper 13 and the leaf 6 of the plant matter are removed in the copying and dyeing step 9.

In addition, when the leaf 6 which sheds the coloring matter 5 is used, the coloring matter 5 is applied after the adherent object including a glue, splay glue, adhesive is attached to the leaf 6 of the plant matter evenly. Then, the coloring matter 5 can be applied certainly to the whole surface of the leaf 6.

For the above-mentioned method 1 for taking a plant print, the coloring matter 5 is applied to the leaf 6, and a part which is applied the coloring matter 5 is copied and dyed to the copied-and-dyed object 8 so that the outline of the leaf 6 and the detail of the leaf vein can be copied and dyed.

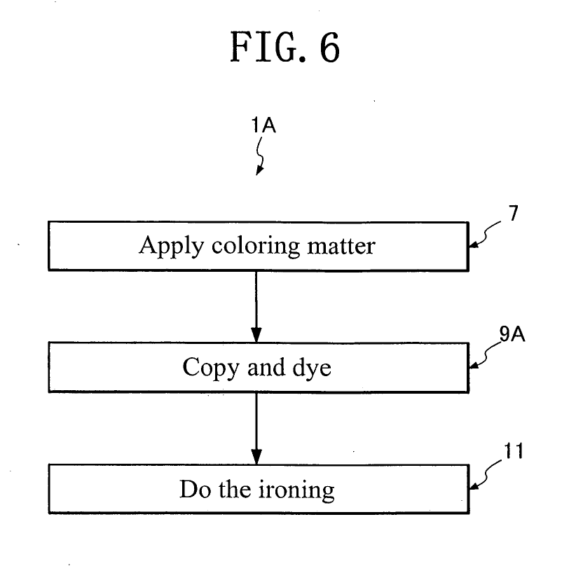

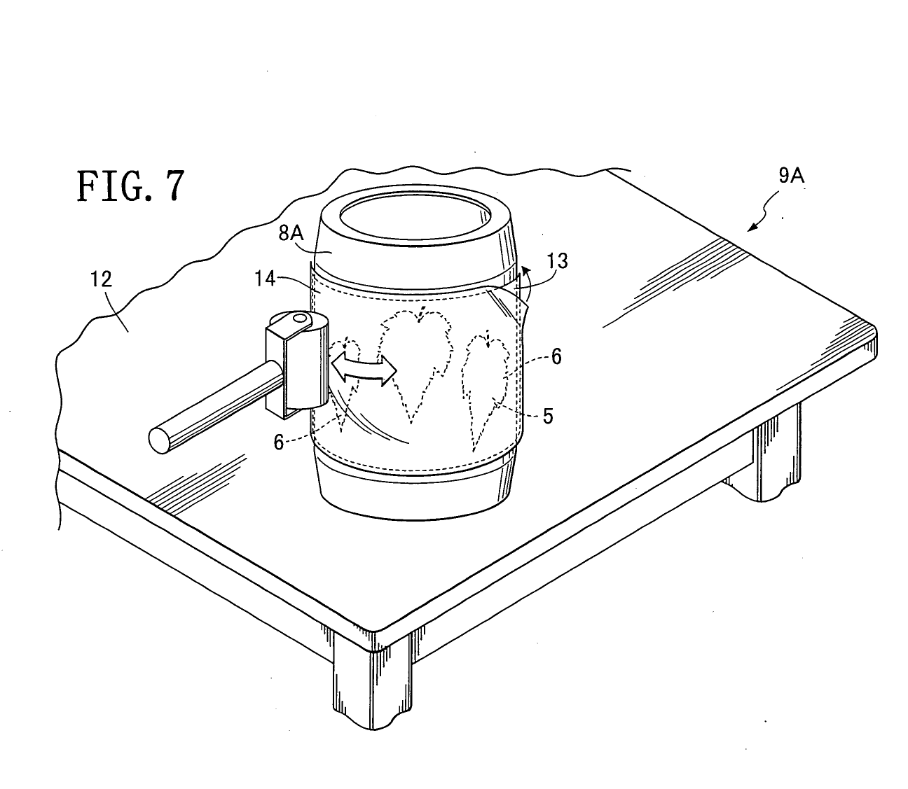

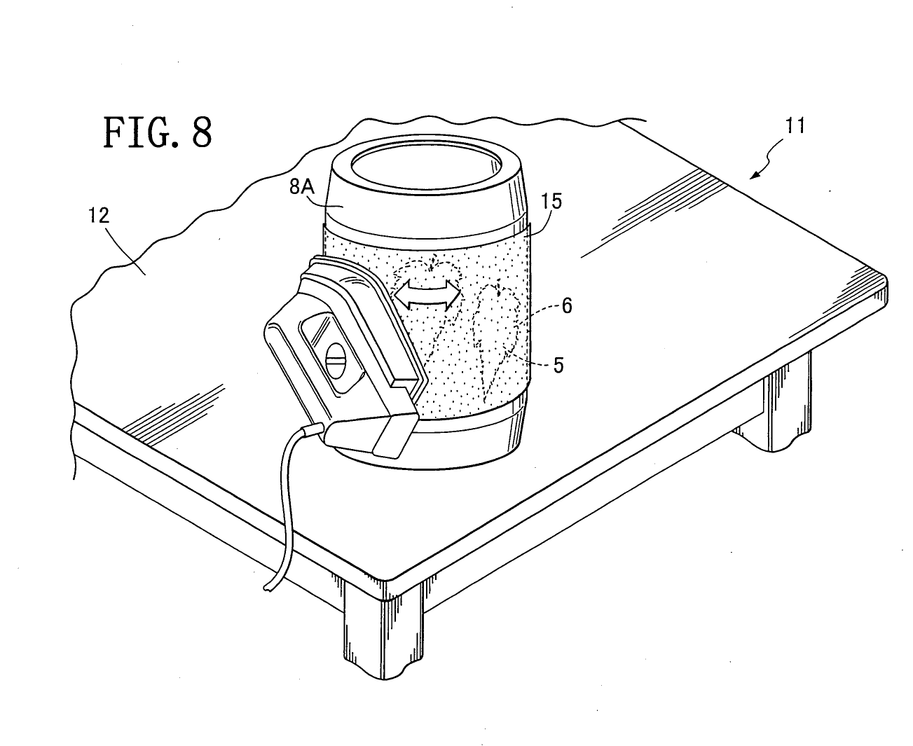

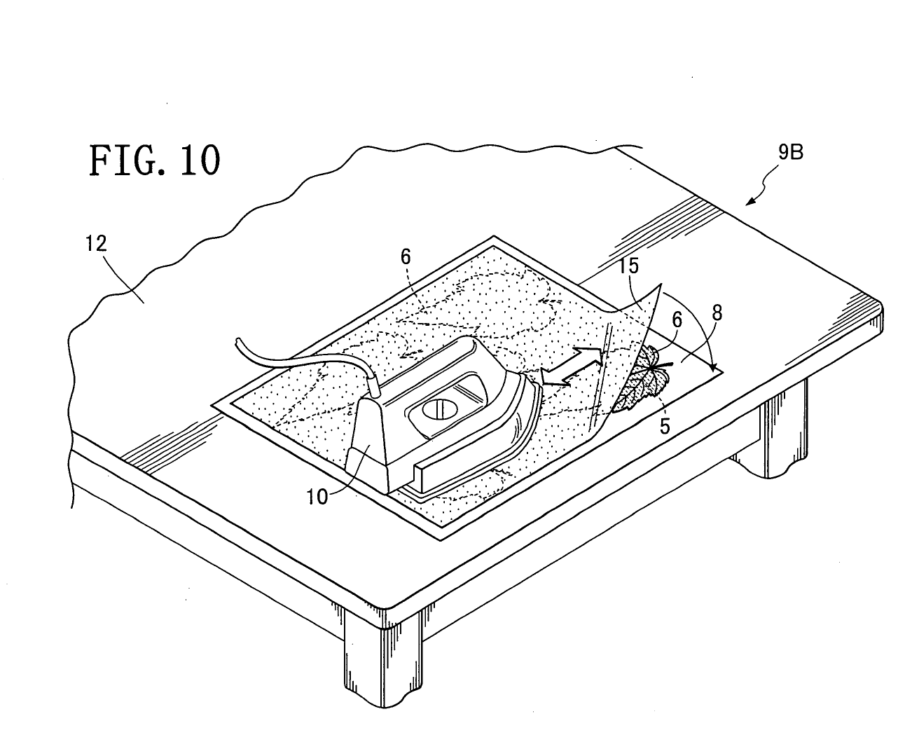

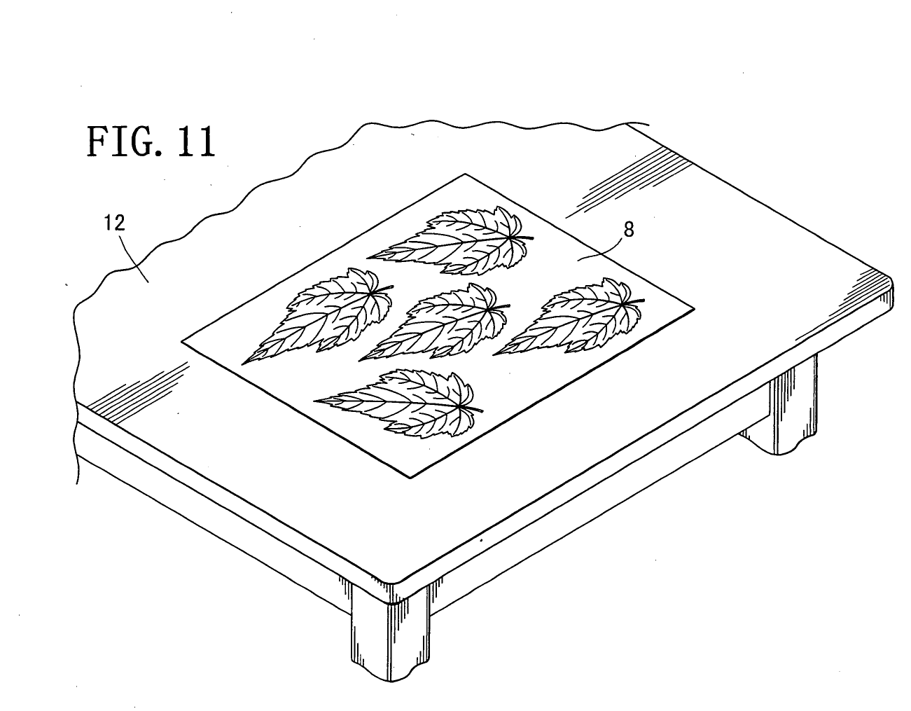

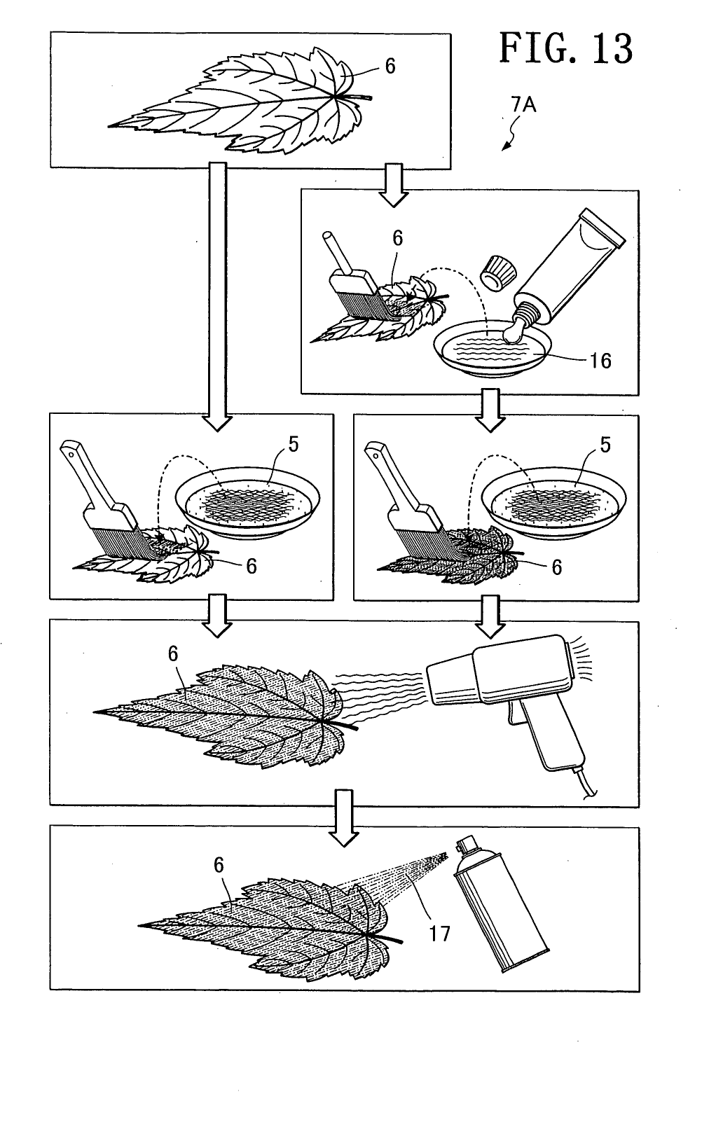

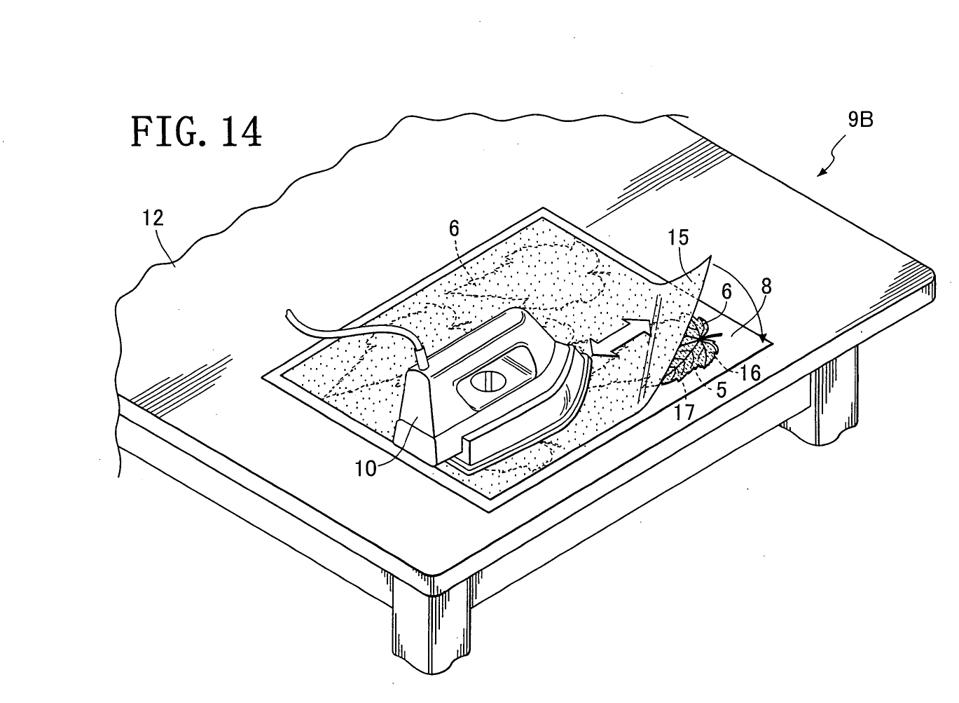

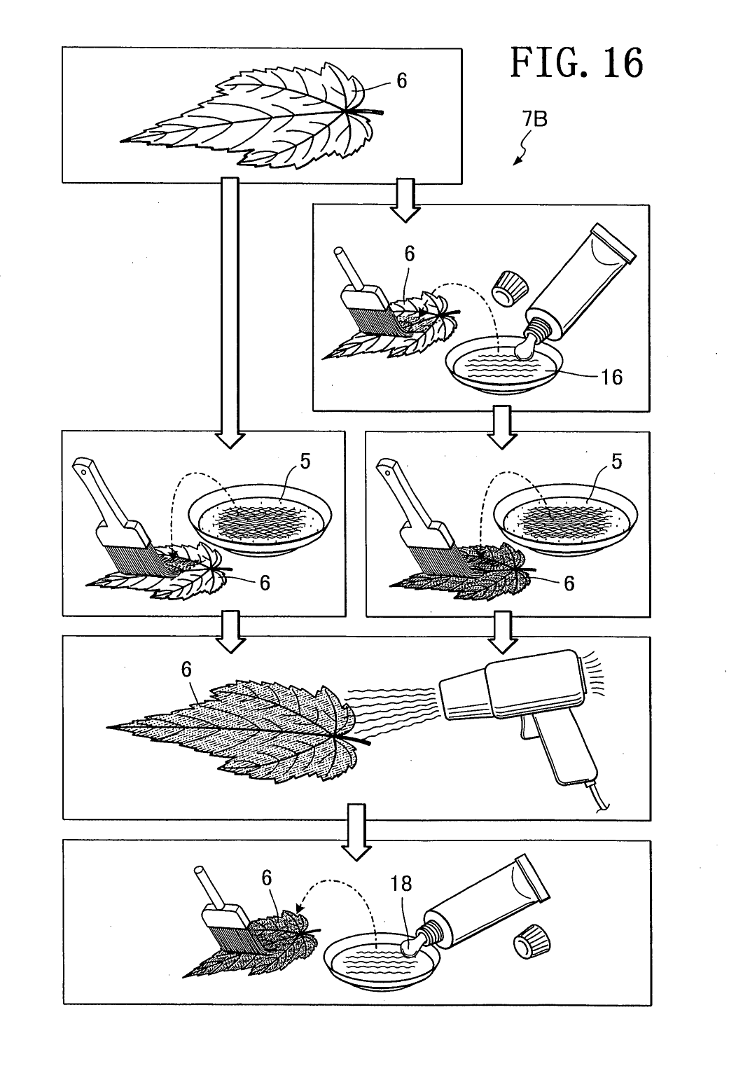

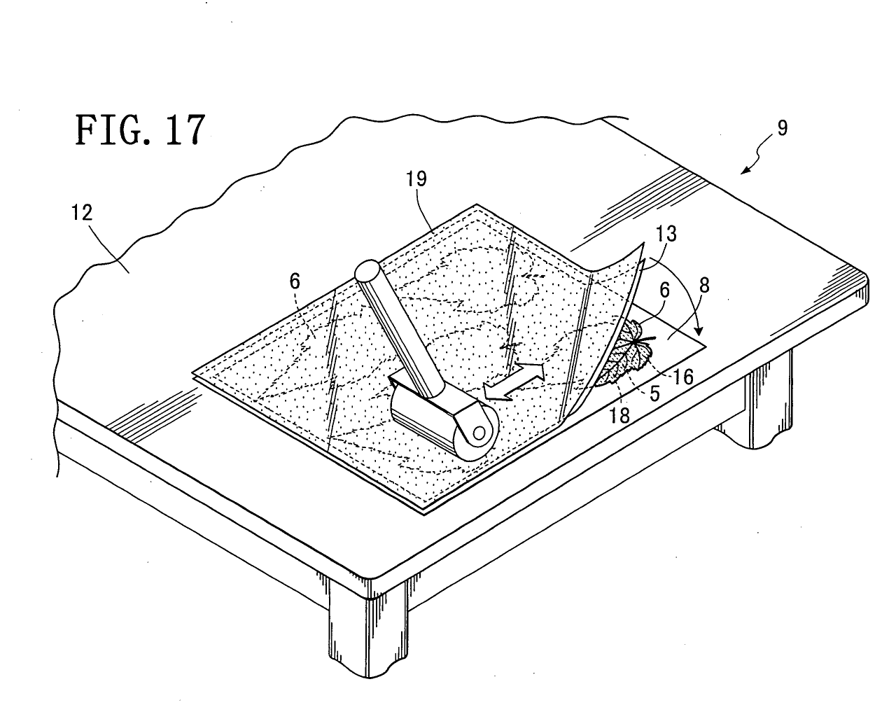

Other embodiments of the present invention will now be described referring to FIGS. 6 to 17. Through the drawings of the embodiments, like components are denoted by like numerals as of the first embodiment and will not be further explained in great detail.

A second embodiment of the present invention is shown in FIGS. 6 to 8 and provides a method 1A for taking a plant matter print distinguished from the first embodiment in that a stereoscopic copied-and-dyed object 8A including an unglazed pottery is processed in a step 9A for copying and dyeing. The method 1A for taking a plant matter print with the step 9A for copying and dyeing according to the second embodiment has similar advantages to that according to the first embodiment.

In addition, in this embodiment, the heating trowel, oven, drier or the like instead of the iron is used in the step 11 for doing the ironing.

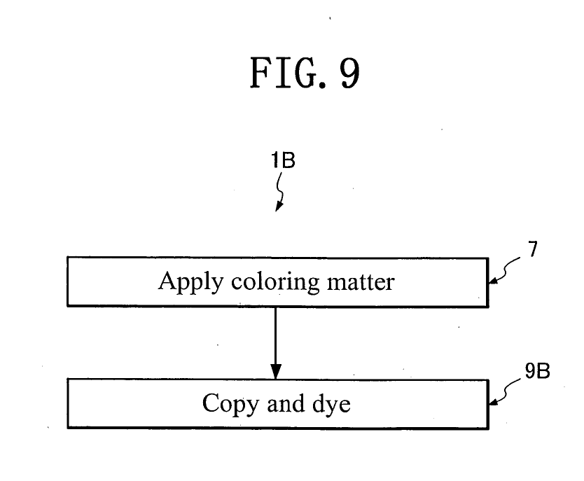

A third embodiment of the present invention is shown in FIGS. 9 to 11 and is distinguished from the first embodiment by the fact that the applying step 7 is replaced with another step 7A and the copying-and-dyeing step 9 is replaced with another step 9B. In the step 7A, the coloring matter 5 is applied to the leaf 6 which is hard to adhere the coloring matter. In the step 9B, the ironing is carried out in the case that the coloring matter 5 is not dried or finishes drying, and it can add the heat with pressure. A method 1B for taking the plant matter print in this way according to the third embodiment has similar advantages to that according to the first embodiment.

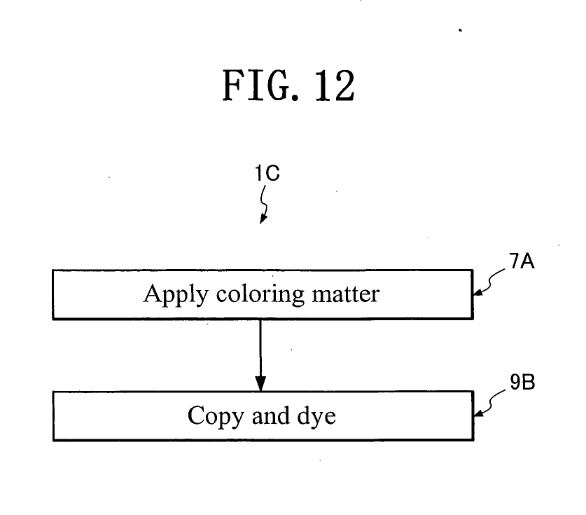

A fourth embodiment of the present invention is shown in FIGS. 12 to 1 4 and is distinguished from the first embodiment by the fact that the applying step 7 is replaced with another step 7A which is applied the coloring matter 5 to the leaf 6 directly or via the adherent object 16 including the glue, splay glue, adhesive, and a hot-melt synthetic resin 17 including an acryl synthetic resin as the fixing agent is applied to the upper surface thereof after the coloring matter 5 is dried. A method 1C for taking the plant matter print in this way according to the fourth embodiment has similar advantages to that according to the first embodiment in the case that the ironing is carried out and it is added the heat with pressure after the surface which is applied hot-melt synthetic resin 17 attaches to the copied-and-dyed object 8 including cloth, paper and the like in the step 7A. In addition, since the hot-melt synthetic resin 17 as the fixing agent is fixed certainly to the copied-and-dyed object 8 has a coarse mesh and dark color, and the membrane thicken, it can be copied and dyed finely.

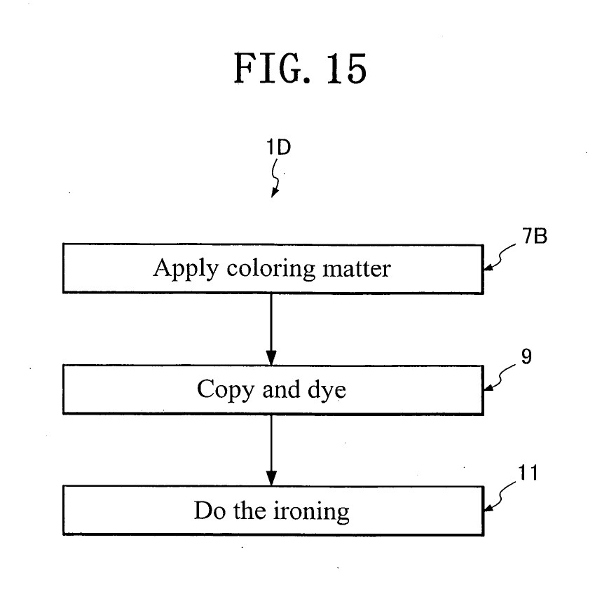

A fifth embodiment of the present invention is shown in FIGS. 15 to 17 and is distinguished from the first embodiment by the fact that the applying step 7 is replaced with another step 7B which is applied the coloring matter 5 to the leaf 6 directly or via the adherent object 16 including the glue, splay glue, adhesive and which is applied the adhesive 18 as the fixing agent on the surface thereof after the applied coloring matter 5 dries. A method ID with the applying step 7B for taking the plant matter print in this way according to the fifth embodiment has similar advantages to that according to the first embodiment in the case that the ironing is carried out by a fingertip, roller, spatula and it is added the heat with pressure after the surface which is applied the adhesive 18 attaches to the copied-and-dyed object 8 including cloth, paper and the like and the an attachment object 19 including a cloth, paper, wood, glass attaches to the back surface of the leaf 6 in the step 7B. In addition, since the hot-melt synthetic resin 17 as the fixing agent is fixed certainly to the copied-and-dyed object 8 has a coarse mesh and dark color, and the membrane thicken, it can be copied and dyed finely.

In addition, in each embodiment in the present invention, the leaf 6 with the plant matter is used. In addition, flower or blanch may be used as the same way of the leaf, living things, pressed flower may be used as the plant matter.

Furthermore, when the pressed flower and thin plant matter are used, they may adhere to the iron when the ironing is carried out. Therefore, the pressed flower or thin plant matter which gets through water may be used, heat is added via the wet compress when the ironing is operated. In this case, it can be improved the problem.

The present invention is utilized in the industrial, business world, education business or the like which copies and dyes the leaf of the plant matter, flower and the like to the paper, cloth and cubic object which are applied the coloring matter.

As set forth above, the advantages of the invention are as follows:

(1) Since the method for taking a plant print includes a step for applying a coloring matter, which is combined the pigment with the fixing agent including acryl emulsion, gum alabic, gum tragacanth or the like and an alcohol, to the leaf and a step for copying and dying the plant matter, which is applied the coloring matter, on the copied-and-dyed object by pushed pressure, the coloring matter which is applied to the plant matter is copied and dyed to the copied-and-dyed object.

Therefore, the outline and color of the plant matter can be copied and dyed to the copied-and-dyed object. (2) As discussed above, since the coloring matter is used, favorite color can be copied dyed to the copied-and-dyed object.

Therefore, it can be selected from a menu of choices and improved.

(3) As discussed above, since the coloring matter, which is combined the pigment with the fixing agent including acryl emulsion, gum alabic, gum tragacanth or the like and an alcohol are used, it does not bubble. In addition, it is higher porous so that it can be applied without patch and can be dried in the short time by alcohol.

(4) As discussed above, since the coloring matter which is applied to the plant matter is copied and dyed to the copied-and-dyed object, it is easy to copy and dye by the pressure rather that the conventional method for copying and dyeing the dye of the plant matter.

(5) As discussed above, since the coloring matter which is applied to the plant matter is copied and dyed to the copied-and-dyed object, any kind of the copied-and-dyed object including paper, cloth cubic object can be copied and dyed easily.

(6) claims 2, 3 and 4 have the same effect as the above (1) to (5), and the plant matter which sheds the coloring matter can be applied the coloring matter. In addition, it can imbibe the dye of the plant matter or stuck-out coloring matter and can be canted out the step for copying and dyeing.

(7) claim 5 has the same effect as the above (1) to (5), since the acryl emulsion, gum alabic, gum tragacanth which are added the pigment are attached to the copied-and-dyed object certainly, and it can be prevented efficiently to lose and change color.

(8) claims 6 and 7 have the same effect as the above (1) to (6).

(9) claim 8 has the same effect as the above (1) to (6), and the plant matter which sheds the coloring matter can be applied the coloring matter. In addition, it can imbibe the dye of the plant matter or stuck-out coloring matter and can be carried out the step for copying and dyeing.

(10) In claim 8, since the fixing agent on the upper surface of the coloring matter is fixed certainly to the copied-and-dyed object has a coarse mesh and dark color, and the membrane thicken, it can be copied and dyed finely.

(11) Claims 9, 10 and 11 have the same effect as the above (1) to (6), (9) and (10).

What is claimed is:

1. A method for taking a plant print comprising the steps of:
applying a coloring matter, which is combined a pigment with a fixing agent including one of acryl emulsion, gum alabic, gum tragacanth or selectively and an alcohol, to a plant matter; and
copying and dyeing the plant matter, which is applied the coloring matter, on a copied-and-dyed object by pushing with pressure.

2. A method for taking a plant print according to claim 1, wherein the applying step applies the coloring matter to the plant matter directly or to the plant matter via an adherent object including one of a glue and an adhesive.

3. A method for taking a plant print according to claim 1, wherein the applying step applies the coloring matter to the plant matter directly or to the pant via the adherent object including one of the glue and the adhesive, and a fixing agent including a hot-melt synthetic resin, the glue, and the adhesive is applied to an upper surface thereof after the coloring matter is dried.

4. A method for taking a plant print according to claim 1, wherein the step for copying and dyeing further comprising step for attaching a surface which is applied the coloring matter to the copied-and-dyed object, putting an absorbent paper and sheet on, and pushing the plant matter to the copied-and-dyed object via absorbent paper and sheet by one of a fingertip, roller and spatula.

5. A method for taking a plant print comprising the steps of:
applying a coloring matter, which is combined a pigment with a fixing agent including one of acryl emulsion, gum alabic, gum tragacanth or selectively and an alcohol, to a plant matter; and
copying and dyeing the plant matter, which is applied the coloring matter, on a copied-and-dyed object by pushing with pressure and with heat.

6. A method for taking a plant print according to claim 5, wherein the applying step applies the coloring matter to the plant matter directly or to the pant via an adherent object including one of a glue and an adhesive.

7. A method for taking a plant print according to claim 5, wherein the applying step applies the coloring matter to the plant matter directly or to the pant via the adherent object including one of the glue and the adhesive, and a fixing agent including a hot-melt synthetic resin, the glue, and the adhesive is applied to an upper surface thereof after the coloring matter is dried.

8. A method for taking a plant print comprising the steps of:
applying a coloring matter, which is combined a pigment with a fixing agent including one of acryl emulsion, gum alabic, gum tragacanth or selectively and an alcohol, to a plant matter;
copying and dyeing the plant matter, which is applied the coloring matter, on a copied-and-dyed object by pushing with pressure; and
doing the ironing by an iron on a back side of the plant matter or a part which is applied the coloring matter.

9. A method for taking a plant print according to claim 8, wherein the applying step applies the coloring matter to the plant matter directly or to the pant via an adherent object including one of a glue and an adhesive.

10. A method for taking a plant print according to claim 8, wherein the applying step applies the coloring matter to the plant matter directly or to the pant via the adherent object including one of the glue and the adhesive, and a fixing agent including a hot-melt synthetic resin, the glue, and the adhesive is applied to an upper surface thereof after the coloring matter is dried.

11. A method for taking a plant print according to claim 8, wherein the step for copying and dyeing further comprising step for attaching a surface which is applied the coloring matter to the copied-and-dyed object, putting an absorbent paper and sheet on, and pushing the plant matter to the copied-and-dyed object via absorbent paper and sheet by one of a fingertip, roller and spatula.
